(19) United States
(12) Patent Application Publication
(10) Pub. No.: US 2018/0127134 A1
(43) Pub. Date: May 10, 2018

(54) Packaging Machine with Trouble Shooting Indicators

(71) Applicant: Schneider Packaging Equipment Co., Inc., Brewerton, NY (US)

(72) Inventor: Peter Squires, Central Square, NY (US)

(73) Assignee: Schneider Packaging Equipment Co., Inc., Brewerton, NY (US)

(21) Appl. No.: 15/804,449

(22) Filed: Nov. 6, 2017

Related U.S. Application Data
(60) Provisional application No. 62/418,230, filed on Nov. 6, 2016.

(51) Int. Cl. B65B 57/18; G08B 3/10; G08B 5/36; G08B 21/18

(52) U.S. Cl. CPC B65B 57/18; G08B 21/182; G08B 5/36; G08B 3/10

(57) ABSTRACT

A trouble shooting system incorporated into a packaging machine. Programmable lighting is employed to visually direct the person to the area of concern or trouble. Through the use of various colors, the person will know whether it is a simple supply issue, i.e. tape supply, label supply, box supply or other supply need to be replenished, or a more substantive maintenance issue. The person will be directed by the lighting directly to the area, thus keeping the machine in production as much as possible.

### REFERENCE TO RELATED APPLICATION

The present application relates and claims priority to Applicant's U.S. Provisional Patent Application Ser. No. 62/418,230, filed Nov. 6, 2016, the entirety of which is hereby incorporated by reference.

### BACKGROUND

### 1. Field of Invention

The present invention relates generally to packaging machines for closing and sealing packages containing products for shipment to a destination, and more particularly to features incorporated into such machines for assistance in trouble shooting maintenance issues.

### 2. Background of Art

Packaging machines, like case packers, palletizer, cartoners or others, operate on a motor-driven conveyor belt type system to close and seal boxes typically containing multiple units of a certain product for subsequent shipping to the product's retail or end user destination. These machines will often operate for long durations in a factory and process thousands of packages over the course of a run. Sometimes maintenance issues arise with the machines and require human intervention to troubleshoot the maintenance issue and then proceed to fix the issue. This maintenance creates significant downtime in the operation of the machine.

When the packaging machine needs human attention, it has been difficult to get the person to the area of interest quickly and knowing what the issue may be. Traditionally, this has been done through an HMI (Human Machine Interface) or monitor with word messages. Sometimes outlines or drawings of the machine are also on the screen highlighting the area to go to. This use of the HMI still takes considerable time in the location of the maintenance issue and the diagnosis of what needs to be done to correct.

### 3. Objects and Advantages

It is therefore a principal object and advantage of the present invention to provide a maintenance trouble shooting system for a packaging machine to decrease downtime associated with machine maintenance.

Other objects and advantages of the present invention will in part be obvious and in part appear hereinafter.

### SUMMARY OF THE INVENTION

In accordance with the foregoing objects and advantages, the present invention provides in one embodiment a trouble shooting system incorporated into a packaging machine. An aspect of the invention uses programmable lighting to visually direct the person to the area of concern or trouble. Through the use of various colors, the person will know whether it is a simple supply issue, i.e. tape supply, label supply, box supply or other supply need to be replenished, or a more substantive maintenance issue. The person will be directed by the lighting directly to the area, thus keeping the machine in production as much as possible.

In one embodiment, the machine includes several LEDs or other illumination sources located at the various stations on the machine. Each of the illumination sources has the capacity to be electronically addressed and emit at least two distinct colors of light. Sensors are located on the various parts of the machine that frequently require maintenance, and when one of these parts is sensed to require maintenance the sensor transmits a signal to the illumination source located adjacent that part. In addition, the illumination source emits a distinct color of light corresponding with the type or category of maintenance issue. In addition, illumination sources can be employed to provide direction to an area of the machine that might otherwise be obfuscated. Thus, for example, if the location in need of maintenance is on the far left side of the machine (which cannot be easily observed due to physical obfuscation of that location), lighting can start on the right of the machine and continuously illuminate lighting towards the direction in need of maintenance (e.g., by scrolling of the light sources).

In one aspect of the invention the color coding and sequencing may also be replicated on the HMI, thereby providing easy visuals to area of machine to go to and type of issue.

A further aspect of the invention comprises automatic task lighting. When the machine detects a person has started to attend to the issue, bright task lighting is automatically turned on in the areas that are helpful to better illuminate the area.

The present system uses a computer program to control the lighting and multicolor lighting. The multicolor lighting allows areas of the machine to be illuminated. The computer controls the color and the sequence of the lights.

### BRIEF DESCRIPTION OF THE DRAWINGS

The present invention will be more fully understood and appreciated by reading the following Detailed Description in conjunction with the accompanying drawings, in which:

FIG. 1 is a perspective view of a packaging machine in accordance with an embodiment of the present invention;

FIG. 2 is a side elevation view thereof;

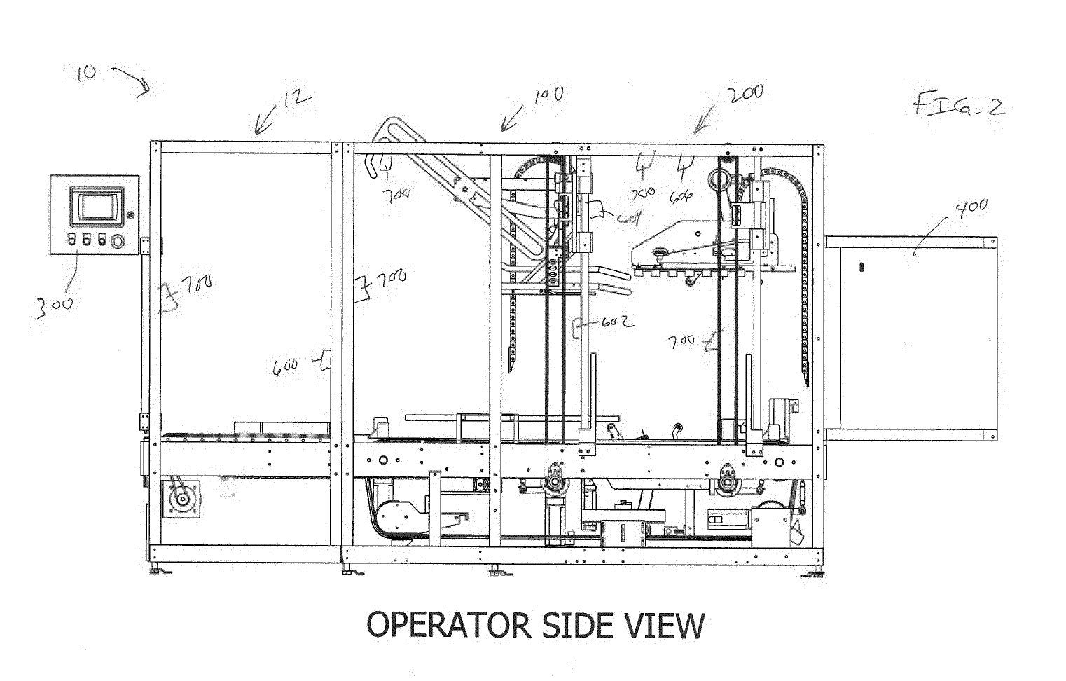

FIG. 3 is a top plan view thereof;

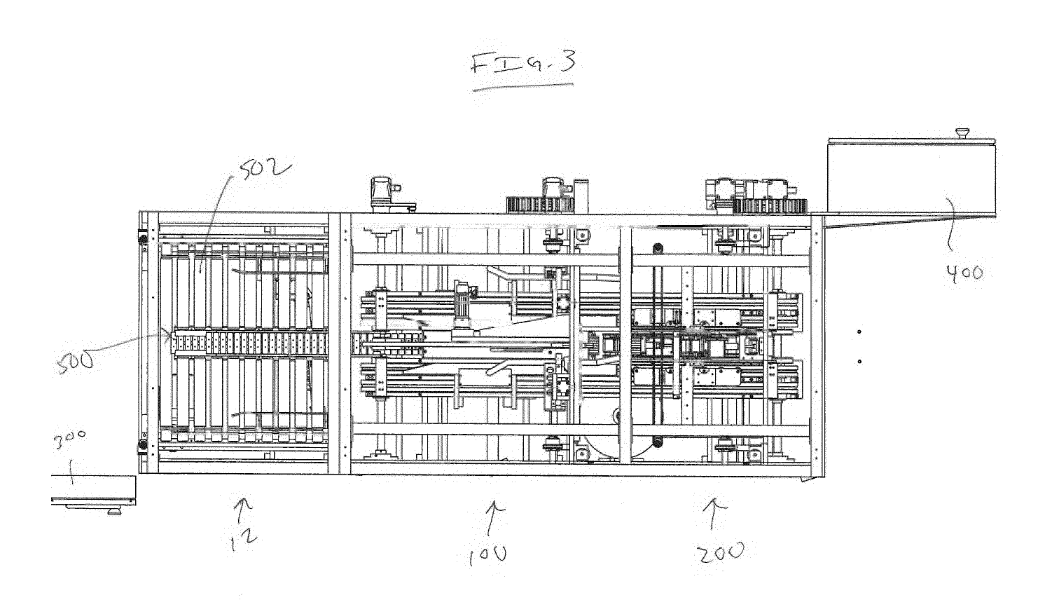

FIG. 4 is an operator end elevation view thereof;

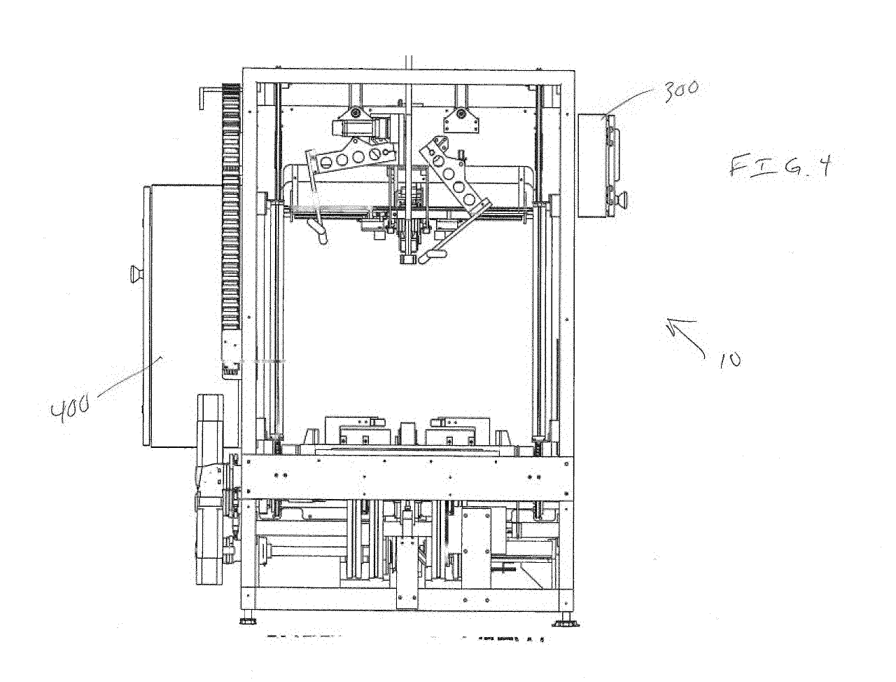

FIG. 5 is a perspective view of an infeed centering and measuring section;

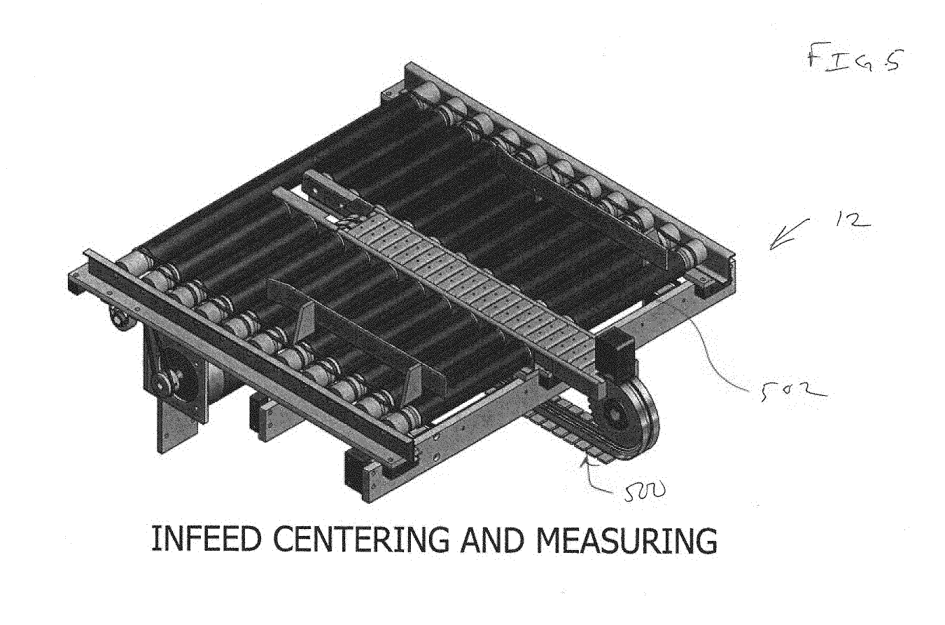

FIG. 6 is a perspective view of a tuck ad flap folding mechanism;

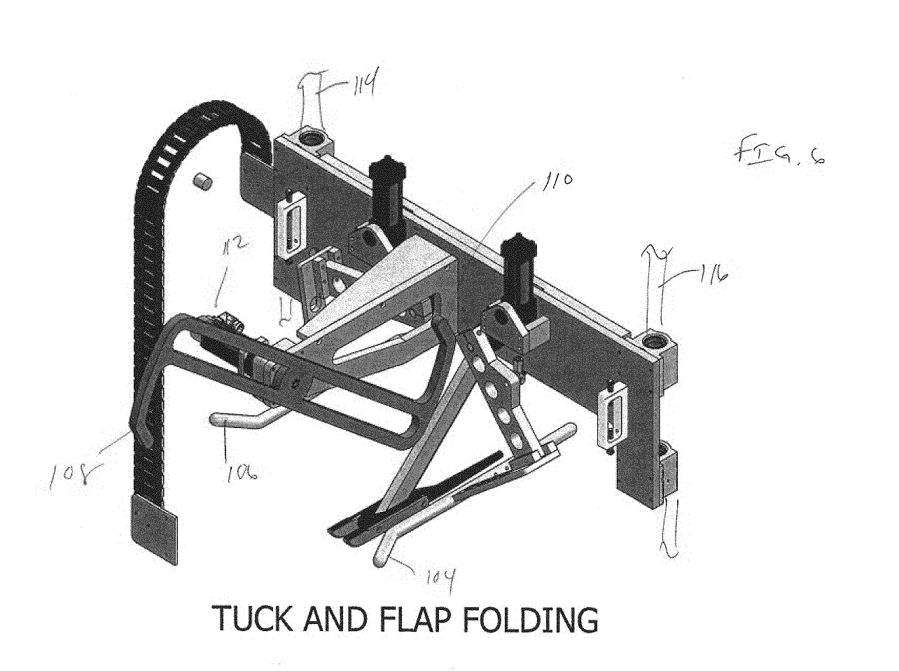

FIGS. 7a and 7b are perspective views of top and bottom sealing devices, respectively;

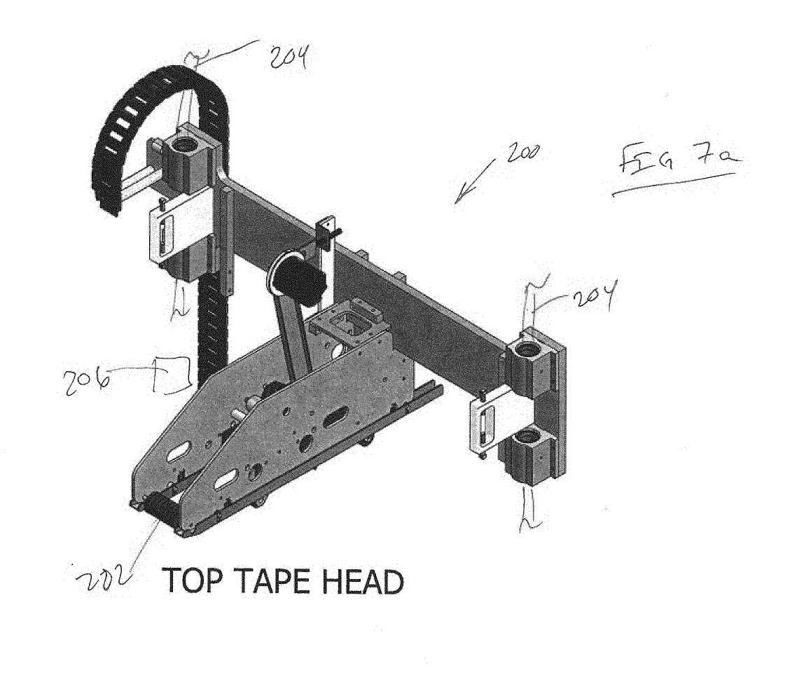

FIG. 8 is a perspective view of a case centering system; and

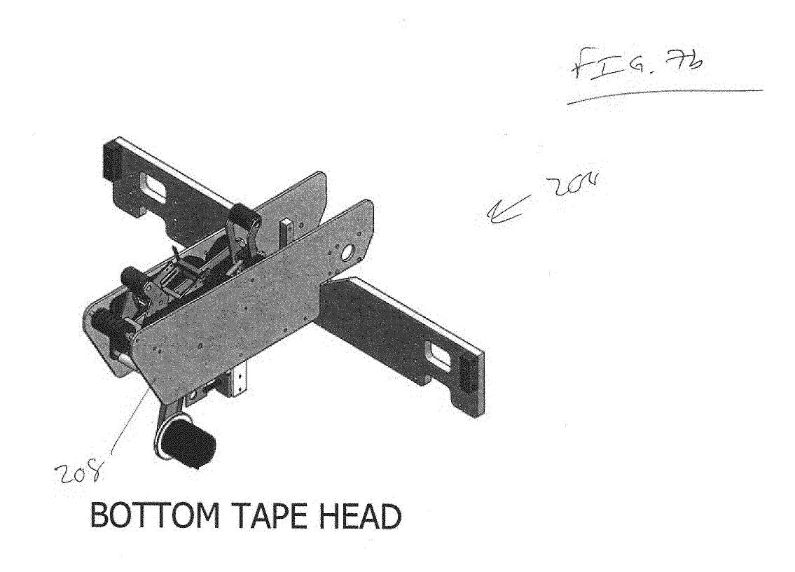

FIG. 9 is a block diagram of the control center; and

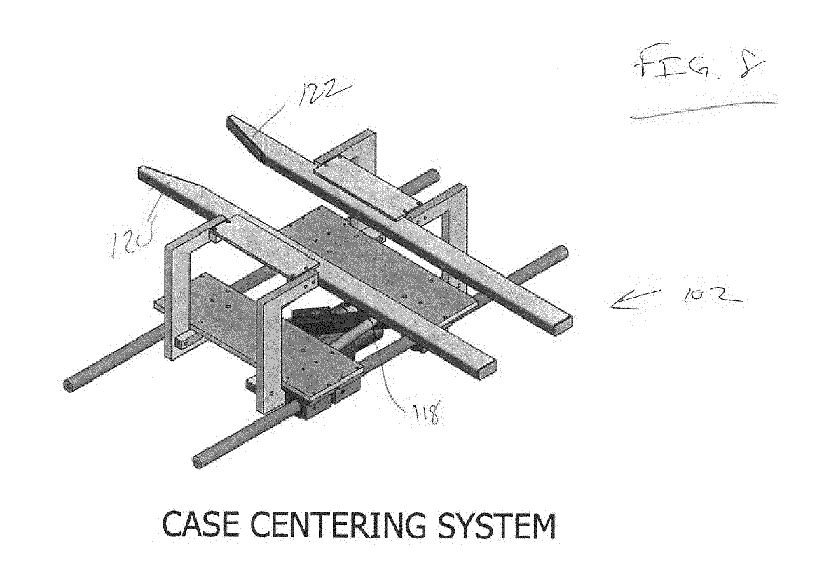

FIG. 10 is a flow chart of the computer program.

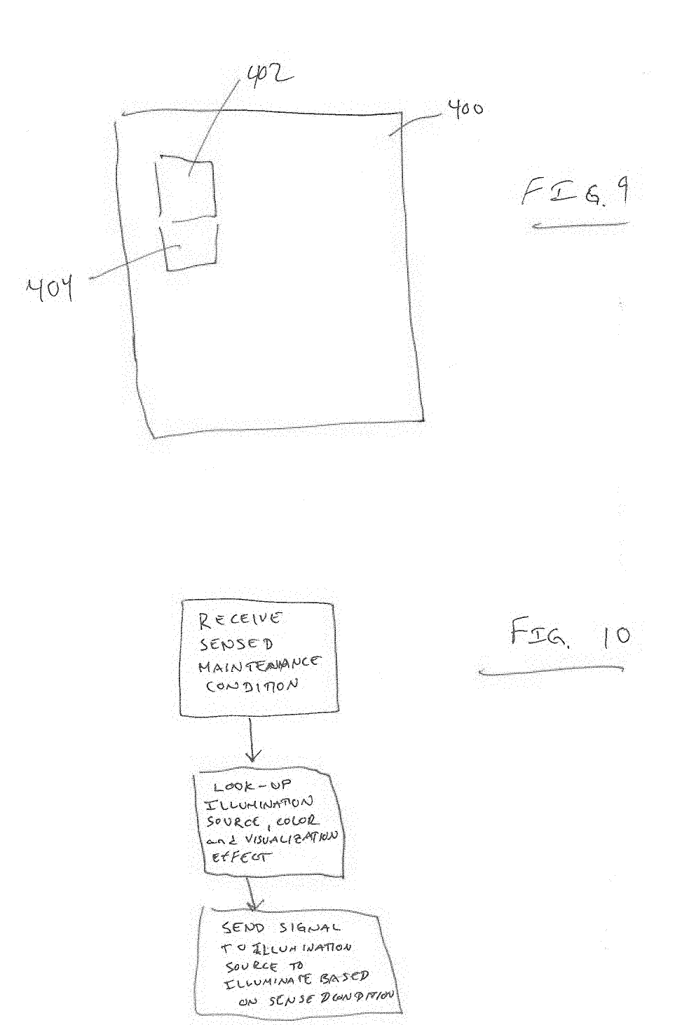

### DETAILED DESCRIPTION

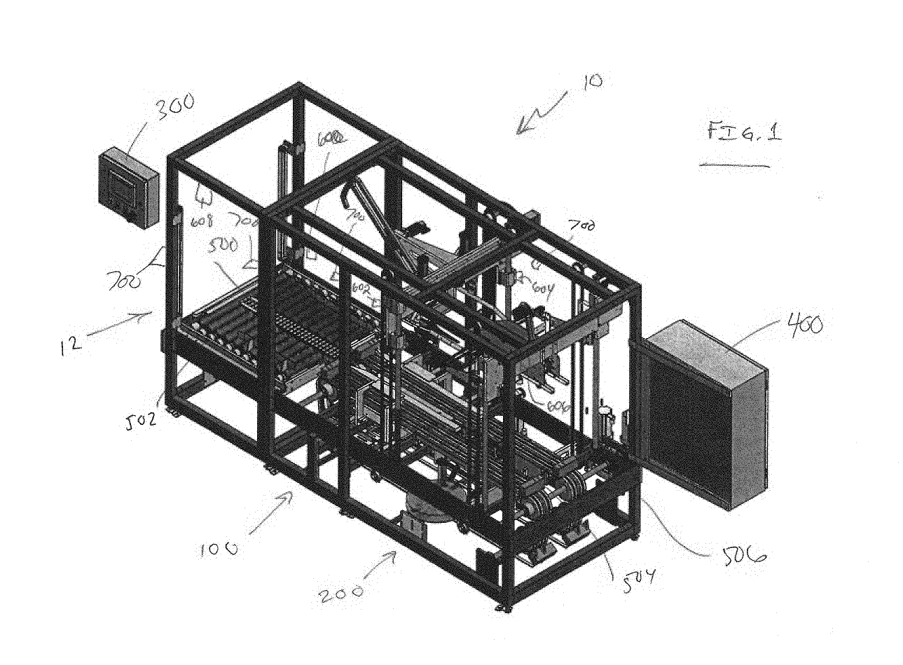

Referring now to the drawings in which like reference numerals refer to like parts throughout, there is seen in FIG. 1 a packaging machine, designated generally by reference numeral 10, for closing and sealing boxes/packages containing predetermined quantities of product such that they may be shipped to a further destination. Packaging machine 10 generally comprises a pre-measurement section 12, a tuck and fold section 100 where the flaps of the packages are tucked/folded from an open to a closed position, and a sealing section 200 that seals the package in its closed position with tape or other adhesive. Further, packaging machine 10 comprises a user/human interface 300 that permits a human operator of machine 10 to input package parameters and other data relating to the running of the machine, and a control system 400 in which a micro-controller 402 and non-transitory memory 404 is housed and which stores the computer programs and data that control the electro-mechanical equipment running machine 10. Finally, a conveyor system 500 is disposed amongst a plurality of rollers 502 to advance packages along the machine 10 for purposes of being processed accordingly. It should be noted that pre-measurement section 12 is an optional portion of machine 10, and that if not used, a measurement device 14 is incorporated into machine 10 in advance of tuck and fold section 100 to perform the measurement needs for the operation of machine 10.

In regard to tuck and fold section 100, it generally comprises a case centering system 102 and side flap tuck arms 104/106 and front and rear flap arms 108/110 (that are part of a single arm assembly that pivots at about its mid-point to engage and tuck the front and rear flaps). Servo-motor 112 drives the vertical positioning of the arms 104-110 along a pair of guide rods 114, 116, based upon the height parameter of the package being processed. In the traditional packaging machines, this is done by entry of the height parameter into the human interface 300 which then drives the motor to adjust to the appropriate height based on that input. The centering system 102 includes a pneumatic or other actuator 118 that pushes centering arms 120, 122 towards or away from one another based upon the width dimension of the packages being processed. The arms 120, 122 apply sufficient pressure on the sides of the package to maintain them in position while the flaps are closed. These aspects of machine 10 are conventional.

In regard to the sealing section 200 it includes a tape applying device 202 that is vertically adjustable along rails 204 to which the device 202 is slidably mounted. A motor 206 drives the tape applying device 202 up or down the rails 204 to the height that permits the tape to be applied across the top of the package and in sealing relation to its flaps. This sealing section 200 is conventional with regard to machine 10.

Conveyor system 500 includes a pair of tracks 504, 506 that are independently driven by motors. This too is a common feature of packaging machines.

Machine 10 is equipped with a plurality of programmable/electronically addressable illumination sources, preferably LEDs, located at various locations around machine 10. In an embodiment of the present invention, an illumination source 600 is positioned at predetermined locations, and will illuminate a predetermined color, for example, red light, and have a particular visualization effect, for example flashing, to indicate a case failure. A sensor can be used to detect a case failure and send a signal to control system 400, which thereby causes the computer program running in the memory therein to cause a signal to be sent to illumination source 600.

A second illumination source 602 positioned at a predetermined location to emit a predetermined color, for example orange, and have a visualization effect, for example flashing fast, to indicate low pressure. A pressure sensor is used to detect the low pressure condition and send the signal to control system 400 and cause the computer program to cause the sending of a signal to illumination source 602.

A third illumination source 604 positioned at a predetermined location near the sealing section 200 and indicates the feeder tape is getting low based upon a sensor detecting this condition and emits a predetermined color, for example amber, with a distinct visualization effect.

A fourth illumination 606 source is positioned at a predetermined location and indicates a feeder jam based upon a sensor detecting this condition and illuminates in a predetermined color, red for example, and with a distinct visualization effect, such as a directional flash. The directional flash causes a series of lights to illuminate in sequence in a direction that leads the operator to the area where the maintenance item is in need of repair/maintenance due to this area otherwise being obfuscated due to the physical structure of the machine.

A fifth illumination source 608 is positioned at various locations around machine 12 and toggle between two colors, blue and white for example, to simply indicate a change in packaging parameters is in progress. Additional illuminations sources can of course be added to indicate different conditions. In addition, other types of indicators asides from illumination sources, such as audible devices that make different sounds, for example, could be employed. Further, a visual graphic based on the indicators could also be displayed on interface 300 to provide the operator with further guidance and indication as to the maintenance issue.

In addition to the condition illumination sources, there are also directional indicators 700 provided in another aspect of the present invention. The directional indicators 700 provide for a sequencing of lights such that a person is directed to the area of interest. If area of interest is at the left end of the machine then sequence of would be right to left, right to left so that a person would be visually directed to the left. If area of interest is in the center of the machine, then sequence would be outside in.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A packaging machine for closing and sealing cases, comprising:
a. a tuck and flap section for closing the cases;
b. a centering mechanism to center the cases on the machine;
c. a sealing section for sealing the cases;
d. a plurality of electronically addressable indicator sources positioned adjacent said tuck and flap section, said centering mechanism, and said sealing section;
e. a plurality of sensors for detecting maintenance items with at least some of said tuck and flap section, said centering section, and said sealing section; and
f. a control center having a micro-controller that comprises non-transitory memory, a receiver for receiving a signal from any one of said plurality of sensors, and a computer readable program stored in said non-transitory memory and comprising computer readable instructions for sending a signal to at least one of said plurality of electronically addressable indicator sources that correlates to said sensed maintenance condition.

2. The packaging machine according to claim 1, further comprising directional indicators mounted at predetermined locations on the machine.

3. The packaging machine according to claim 2, wherein said directional indicators comprise a plurality of lights adapted to illuminate in sequence for purposes of directing a user to a predetermined location on the machine.

4. The packaging machine according to claim 1, wherein said plurality of indicator sources are lights.

5. The packaging machine according to claim 4, wherein each of said plurality of indicator sources emit at least one predetermined color light.

6. The packaging machine according to claim 5, wherein each of said plurality of indicator sources is adapted to illuminate with a predetermined visualization effect.

7. The packaging machine according to claim 1, wherein each of said plurality of indicator sources are audible devices.

8. The packaging machine according to claim 1, wherein said plurality of indicator sources comprise any combination of: a first indicator source adapted to indicate a case failure, a second indictor source adapted to indicate a low pressure condition, a third indicator source adapted to indicate a feeder tape becoming low, a fourth indicator to indicate feeder jam, a fifth indicator source to indicate a change in packaging parameters is in progress, and a plurality of directional indicators adapted to direct a predetermined location on the machine.

9. A computer program product for actuating indication sources in a packaging machine for closing and sealing cases, the packaging machine comprising a tuck and flap section for closing the cases; a centering mechanism to center the cases on the machine; a sealing section for sealing the cases; a plurality of electronically addressable indicator sources positioned adjacent the tuck and flap section, the centering mechanism, and the sealing section; and a plurality of sensors for detecting maintenance items with at least some of the tuck and flap section, the centering section, and the sealing section, said computer program product comprising a computer readable storage medium having program instructions embodied therewith, wherein the computer readable storage medium is not a transitory signal per se, the program instructions executable by a processor to cause the machine to actuate at least one of said plurality of indicator sources upon receipt of a signal from a corresponding one of said plurality of sensors.

10. The computer program product according to claim 9, wherein said program instructions further cause said plurality of indicator sources to indicate according to a predetermined effect.

11. A method for providing indication to a packaging machine for closing and sealing cases of a predetermined trouble shooting item, comprising the steps of:
a. receiving a signal from a sensor associated with a predetermined part of the packaging machine; and
b. electronically actuating at least one indication source that is associated with the sensor that sent the signal.
